(19) United States
(12) Patent Application Publication
(10) Pub. No.: US 2024/0426098 A1
(43) Pub. Date: Dec. 26, 2024

(54) CONSTRUCTION MANAGEMENT SERVICES, EMERGENCY STAGES AND SHELTERS

(71) Applicant: CRC Innovation LLC, Southlake, TX (US)

(72) Inventors: Tad William Eckerle, Fort Worth, TX (US); William Francis Timothy Eckerle, Arlington, TX (US)

(21) Appl. No.: 18/752,016

(22) Filed: Jun. 24, 2024

Related U.S. Application Data
(60) Provisional application No. 63/522,657, filed on Jun. 22, 2023.

(51) Int. Cl. E04B 1/84; E04B 1/66; E04B 1/82; G10K 11/168

(52) U.S. Cl. CPC E04B 1/84; E04B 1/66; G10K 11/168; E04B 2001/8263

(57) ABSTRACT

A system for sound attenuation and sound abatement includes a structural column, a mounting member, insulation, an architectural membrane, a vapor barrier, a first sound mitigation layer, and an acoustic blanket. The structural column includes a first flange, a second flange, and a connecting portion. The mounting member is attached to a front side of the second flange of the structural column. The insulation is disposed between the first flange and the second flange of the structural column. The architectural membrane is disposed in part behind the first flange of the structural column and configured to partially cover the insulation. The vapor barrier is disposed in part behind the second flange of the structural column and configured to partially cover the insulation. The first sound mitigation layer at least partially covers the mounting member. The acoustic blanket at least partially covers the sound mitigation layer.

### TECHNICAL FIELD

This disclosure relates generally to construction management services, emergency stages, and shelters, and more particularly, to soundstage sound attenuation systems for use with tension membrane structures.

### BACKGROUND

From the early 20^{th} century, soundstages have served as foundational components of filmmaking and offered controlled environments for production. Since then, despite significant technological advancements in other areas of the film industry, the fundamental design of soundstages themselves has remained remarkably consistent. While improvements in soundproofing materials and lighting technology have enhanced their functionality, soundstages, characterized by large, soundproofed spaces and heavy load-bearing structures capable of supporting adjustable lighting rigs and versatile backdrops, have undergone minimal changes in their basic architecture. Further, due to the lack of set soundproofing standards, there is a high variability in sound abatement between soundstages, leaving sound engineers, production sound mixers, and sound technicians to iterate their approaches depending upon the filming site.

Therefore, there exists a need for a soundproofing system with consistent acoustic standards which is incorporable into more lightweight, easily-manufactured structures.

### SUMMARY

An aspect of this disclosure provides a system for sound attenuation and sound abatement. The system for sound attenuation and sound abatement includes a structural column, a mounting member, insulation, an architectural membrane, a vapor barrier, a first sound mitigation layer, and an acoustic blanket. The structural column includes a first flange, a second flange, and a connecting portion. The mounting member is attached to a front side of the second flange of the structural column. The insulation is disposed between the first flange and the second flange of the structural column. The insulation is configured to dampen sound. The architectural membrane is disposed in part behind the first flange of the structural column and configured to partially cover the insulation. The vapor barrier is disposed in part behind the second flange of the structural column and configured to partially cover the insulation. The first sound mitigation layer at least partially covers the mounting member. The acoustic blanket at least partially covers the sound mitigation layer.

In another aspect of this disclosure, the system may further include a second sound mitigation layer disposed between a front side of the second flange of the structural column and the mounting member.

In yet another aspect of this disclosure, the mounting member may be fabricated from at least one of aluminum or fire-retardant treated wood.

In a further aspect of this disclosure, the structural column may further define a slot on at least one of the first flange or the second flange The slot may be configured to accommodate a fastener.

In another aspect of this disclosure, a fastener at least partially disposed within the slot may attach the mounting member to the structural column.

In yet another aspect of this disclosure, the insulation may include a first insulation layer and a second insulation layer.

In a further aspect of this disclosure, the system may further include an insulation blanket flap. The insulation blanket flap may be at least partially adhered to the connecting portion of the structural column.

In another aspect of this disclosure, the vapor barrier may be integrated with the insulation.

In yet another aspect of this disclosure, the insulation may have a thickness of at least 14 inches.

In a further aspect of this disclosure, the sound mitigation layer may be mass-loaded vinyl.

In another aspect of this disclosure, the system may meet a sound transmission class (STC) rating of at least 48.

In yet another aspect of this disclosure, the system may meet a noise criterion (NC) rating of 15 or less.

In a further aspect of this disclosure, the system may have a noise reduction coefficient (NRC) of at least 0.9.

An aspect of this disclosure provides a system for sound attenuation and sound abatement. The system for sound attenuation and sound abatement includes insulation, a vapor barrier, a first sound mitigation layer, and an acoustic blanket. The insulation is configured to dampen sound and configured to be disposed between a first flange and a second flange of a structural column. The vapor barrier is configured to at least partially cover the insulation. The first sound mitigation layer is configured to at least partially cover a mounting member when the mounting member is attached to the structural column. The acoustic blanket is configured to at least partially cover the sound mitigation layer.

In another aspect of this disclosure, the system may further include a second sound mitigation layer configured to be disposed between a front side of the second flange of the structural column and the mounting member.

In yet another aspect of this disclosure, the insulation may have a thickness of at least 14 inches.

In a further aspect of this disclosure, the system may meet a sound transmission class (STC) rating of at least 48.

In another aspect of this disclosure, the system may meet a noise criterion (NC) rating of 15 or less.

In yet another aspect of this disclosure, the system may have a noise reduction coefficient (NRC) of at least 0.9.

An aspect of this disclosure provides a method of sound attenuation and sound abatement. The method of sound attenuation and sound abatement includes inserting insulation between a first flange and a second flange of a structural column, wherein the insulation spans an area across which sound dampening is desired; adhering a first sound mitigation layer to a front side of the second flange of the structural column; attaching a mounting member to the structural column, wherein the first sound mitigation layer is disposed at least partially between the mounting member and the structural column; at least partially covering the mounting member with a second sound mitigation layer, wherein the second sound mitigation layer spans at least the area across which sound dampening is desired; and at least partially covering the mounting member with an acoustic blanket, wherein the acoustic blanket spans at least the area across which sound dampening is desired.

Further details and aspects of the present disclosure are described in more detail below with reference to the appended drawings.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a top-down section view of an exemplary soundstage sound attenuation system, in accordance with aspects of this disclosure;

FIG. 2 shows the soundstage sound attenuation system of FIG. 1 as incorporated into a tension membrane structure, in particular, a side section view illustrating the manner by which the system is mounted, in accordance with aspects of this disclosure;

FIG. 3A displays a top-down section view of the soundstage sound attenuation system of FIG. 1, including an acoustic blanket and mass-loaded vinyl, in accordance with aspects of this disclosure;

FIG. 3B illustrates a front view of the system of FIG. 3A, with the acoustic blanket and mass-loaded vinyl omitted for clarity, in accordance with aspects of this disclosure;

FIG. 4 portrays a perspective view of a framing for the system of FIG. 1, in accordance with aspects of this disclosure;

FIG. 5 illustrates a front perspective view of the framing of FIG. 4 including soundproofing components, in accordance with aspects of this disclosure; and

FIG. 6 shows a front view of an alternate mounting structure for the system of FIG. 1, in accordance with aspects of this disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Standard soundstages are often expansive structures which are capable of bearing heavy loads, as they must be able to support a broad range of equipment, including anything from dense soundproofing materials to lighting rigs. As such, soundstage construction can often be costly and cumbersome. A solution to this may be found in tension membrane structures. While most structures rely on the principle of compression to ensure durability and robustness, tension membrane structures rely on the principle of tension, where a thin, flexible material is stretched and anchored to maintain the shape and stability of the structure. The material of tension membrane structures is typically a fabric or membrane, and may be a weather-resistant material such as PTFE-coated fiberglass or PVC-coated polyester, to ensure durability. Tensile elements in tension membrane structures may be cables and metal supports or beams. The materials and configuration of tension membrane structures allows them to span large distances without the need for intermediate supports, resulting in lightweight, efficient structures that are faster and simpler to construct compared to traditional buildings. Moreover, due to the reduced amount of material required for construction, tension membrane structures provide a cost-effective alternative to traditional buildings.

In addition to traditional soundstages being unwieldy to install, they lack a consistent code or standard for soundproofing that must be met, resulting in irregular recording conditions between soundstages. Soundstages can vary wildly in sound transmission class (STC), noise criterion (NC) and noise reduction coefficient (NRC) rating. Thus, this disclosure provides a system for sound attenuation and sound abatement which is easily incorporated into a tension membrane structure, and which provides consistent sound attenuation results.

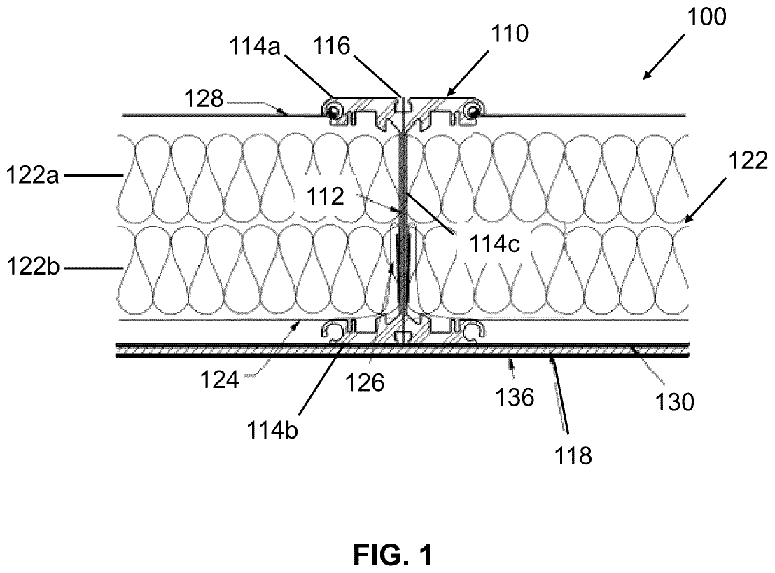

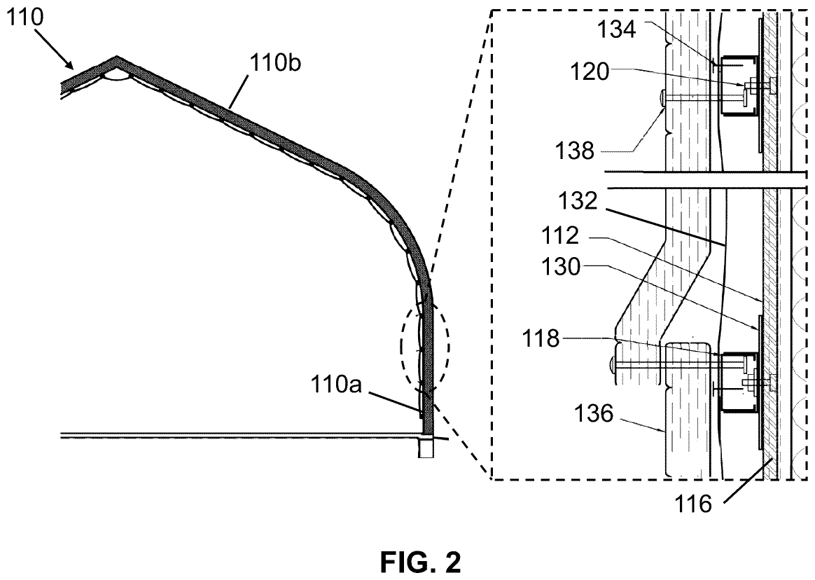

Referring to FIG. 1, a system 100 for sound attenuation and sound abatement generally includes insulation 122, a sound mitigation layer 132 (FIG. 2), and an acoustic blanket 136. The sound mitigation layer 132 may be mass-loaded vinyl (MLV) or other flexible, durable, high-density product configured to reduce noise. For example, sound mitigation layer 132 may be a viscoelastic damping compound, foam, rubber, cork, fiberglass, or the like. Depending upon soundproofing needs, a plurality of sound mitigation layers 132 may be incorporated into system 100. Each sound mitigation layer 132 may have a thickness of approximately ⅛ of an inch, though other thicknesses are acceptable as well. Acoustic blanket 136 (e.g., sound blanket, sound absorption blanket) may be any blanket used to reduce noise, and may typically be constructed from layers of dense, sound-absorbent material such as fiberglass, foam, or cotton, encased in a fabric covering. For example, acoustic blanket 136 may be Insul-Quilt™ Sound Absorbing Blanket or the like. System 100 is configured to be incorporated into a structure 110, more specifically, a tension membrane structure.

Structure 110 includes a structural column 112, which in aspects, may be an I-beam or the like. Structural column 112 may include a first flange 114a, a second flange 114b, and a connecting portion 114c. First flange 114a and second flange 114b may be parallel to one another, with connecting portion 114c perpendicular to and connected to each. An architectural membrane 128 may connect to first flange 114a, particularly, a back side of first flange 114a. Architectural membrane 128 may be formed of a thin, flexible, durable material, for example, PVC-coated polyester, PTFE-coated fiberglass, ETFE foil, or the like. In aspects, architectural membrane 128 may have inherent sound absorption properties, and may be a high-density material. Insulation 122 is configured to be disposed between the first flange 114a and the second flange 114b of structural column 112. In aspects, insulation 122 may include a first insulation layer 122a disposed adjacent a second insulation layer 122b, thus forming dual layer insulation. Insulation 122 may be formed from fiberglass, and may have a minimum total thickness of 14 inches to provide sufficient sound dampening.

In aspects, system 100 may further include a vapor barrier 124, which may be disposed on insulation 122. A portion of vapor barrier 124 may be disposed partially on a back side of second flange 114b of structural column 112. Vapor barrier 124 is configured to prevent moisture from penetrating insulation 122. In aspects, vapor barrier 124 may be integral to insulation 122. For example, vapor barrier 124 may be a vapor barrier backing on insulation 122. Vapor barrier 124 may wrap partially around insulation 122 to prevent water vapor from contacting insulation 122. In aspects, system 100 may further include an insulation blanket 126 which may be adhered to either side of connecting portion 114c of structural column 112. Vapor barrier 124 may tuck into a portion of insulation blanket 126.

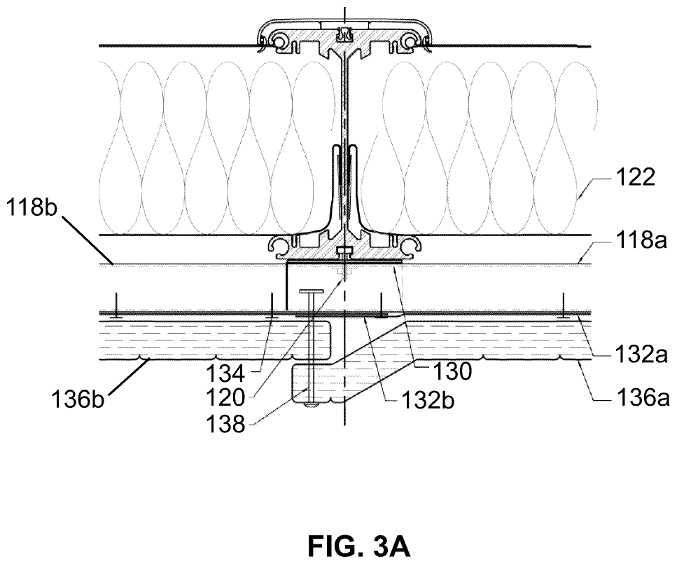

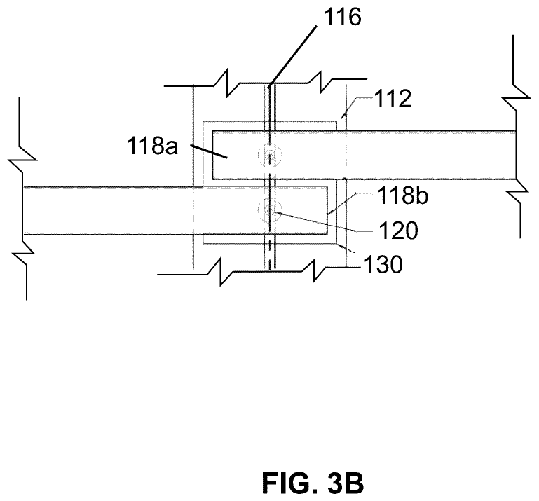

On a front side of second flange 114b, structure 110 includes a mounting member 118 which is connected to structural column 112. Mounting member 118 may be connected to structural column 112 by a fastener 120 (FIG. 3) for example, any combination of a screw, a bolt, a nut, a threaded rod, a pin, a T-bolt, or the like, or by any other acceptable means, for example, welding or adhesive. Fastener 120 may be disposed within a slot 116 of structural column 112. As will be described in greater detail regarding FIG. 2, slot 116 may be a T-slot capable of accommodating a head of fastener 120. In aspects, a sound mitigation segment 130 may be disposed between mounting member 118 and structural column 112. Sound mitigation segment 130 may be manufactured from the same material as sound mitigation layer 132, for example, sound mitigation segment 130 may be mass-loaded vinyl or another flexible, dense, material configured for soundproofing. Sound mitigation segment 130 may include adhesive, for example, sound mitigation segment 130 may be a mass-loaded vinyl tape, or the like. In aspects, sound mitigation segment 130 may be replaced by an additional sound mitigation layer 132. Acoustic blanket 136 is disposed on an opposite side of mounting member 118. A sound mitigation layer 132 may additionally be disposed on an opposite side of mounting member 118. It is also contemplated that acoustic blanket 136 may instead, or additionally, be disposed between mounting member 118 and structural column 112.

FIG. 2 shows structure 110 as includes system 100. Structure 110 may include a vertical portion 110a as well as a curved portion 110b. Spacing between mounting members 118 may differ based upon whether each mounting member 118 is installed on the vertical portion 110a or the curved portion 110b of structure 110. A configuration of system 100 as installed on vertical portion 110a of structure 110 is shown. Mounting member 118 may be fabricated from a metal, such as aluminum, and may be a singular piece or a combination of pieces. For example, mounting member 118 may be an interlocking aluminum “box” rail. That is, mounting member 118 may be an aluminum track coupled to an aluminum stud. Mounting member 118 may be light-gauge, providing reduced weight while still configured to support axial loads. Depending upon a span of mounting member 118, outside dimensions of mounting member 118 may differ. For example, for a span of about 12.5 feet, mounting member 118 may have a width or thickness of between about 1.25 inches to about 1.5 inches. For longer spans, such as 18.5 foot spans, mounting member 118 may have a width or thickness of about 1.5 inches. Other spacing and spans are also contemplated. Structure 110 may include a plurality of mounting members 118 installed vertically or horizontally, depending upon the configuration of structure 110 and/or support or soundproofing needs. Mounting members 118 may be evenly spaced over structure 110 or may have different spacing depending upon whether the mounting member 118 is installed on vertical portion 110a or curved portion 110b, or depending upon other requirements. As shown, mounting members 118 may be installed horizontally on vertical portion 110a, and may be spaced about 2 feet on center from one another.

As shown, each mounting member 118 may be fastened to structural member 112 via fastener 120 disposed in part within slot 116. Fastener 120 may include a threaded rod, a washer, and a nut, or any other suitable fastening components. As shown, a threaded rod and nut, may be inserted into slot 116, and mounting member 118 may be attached to the threaded rod and nut and secured using a washer and an additional nut. Alternatively, mounting member 118 may be attached using a bolt, with ahead of the bolt inserted into slot 116. Mounting member 118 may then be secured using a washer and a nut. A suitable diameter of the threaded rod or bolt may be approximately ⅜ of an inch, with the washer and the nut having a 1.5-inch diameter. Other suitable diameters are also contemplated. As previously noted, prior to securing mounting member 118 to structural column 112, sound mitigation segment 130 may be adhered or otherwise attached to structural column 112.

On a side of mounting member 118 which is not attached to structural column 112 or sound mitigation segment 130, sound mitigation layer 132 may be connected. Sound mitigation layer 132 may be fastened to mounting member 118 by a fastener 134, such as a screw or a staple. Other appropriate means of fastening, such as adhesive, are also contemplated.

As shown more clearly in FIG. 3, sound mitigation layer 132 may include portions which overlap and are held together by fasteners 134. Fasteners 134 may also be disposed at regular, or irregular, intervals across a span of sound mitigation layer 132. Acoustic blanket 136 may be mounted atop sound mitigation layer 132 and fastener 134. Acoustic blanket 136 may be of a thickness sufficient to dampen sound or sonic waves, for example, about 2 inches thick. Like sound mitigation layer 132, acoustic blanket 136 may be attached to mounting member 118 and/or sound mitigation layer 132 using a fastener 138. Fastener 138 may be any fastener suitable for use with acoustic blanket 136, for example, a coarse screw with a wide head and/or a washer, a staple, or the like. Acoustic blanket 136 may overlap in portions, therefore, a length of each fastener 138 may depend upon a thickness of acoustic blanket 136.

Referring to FIGS. 3A and 3B, FIG. 3A illustrates a top-down section view of system 100 while FIG. 3B shows a front view of the configuration of FIG. 3A. FIG. 3A includes overlapping sound mitigation layers 132 as well as overlapping acoustic blankets 136, while FIG. 3B omits each for clarity purposes. Mounting members 118 may be vertically stacked and/or horizontally staggered on structural column 112 in order to accommodate spans required across structure 110. For example, as shown, a first mounting member 118a may be installed vertically above a second mounting member 118b. An end of first mounting member 118a may horizontally extend past an end of second mounting member 118b. First mounting member 118a and second mounting member 118b may form a mounting member set. As shown, sound mitigation segment 130 may be disposed on structural column 112 and behind each of mounting members 118a, 118b. Additionally, a fastener 120 may connect each mounting member 118a, 118b to structural column 112 by way of slot 116, thus a mounting hole disposed through each of mounting member 118a, 118b may be vertically aligned.

FIG. 3A additionally illustrates overlapping sound mitigation layers 132 and acoustic blankets 136. A first sound mitigation layer 132a may be fastened to first mounting member 118a via fasteners 134, while a second sound mitigation layer 132b may be fastened to second mounting member 118b by fasteners 134. Where first and second mounting members 118a, 118b horizontally overlap, first sound mitigation layer 132a may overlap second sound mitigation layer 132a, and one or more fasteners 134 may secure both first and second sound mitigation layers 132a, 132b to any or each of first and second mounting members 118a, 118b. Similarly, fasteners 138 may secure a first acoustic blanket 136a over first sound mitigation layer 132a and to first mounting member 118a, while fasteners 138 secure a second acoustic blanket 136b over second sound mitigation layer 132b and to second mounting member 118b. First and second acoustic blankets 136a, 136b may overlap where first and second mounting members 118a, 118b overlap, and one or more fasteners 138 may secure both first and second acoustic blankets 136a, 136b to one or both of first and second mounting members 118a, 118b.

It is contemplated that each structural column 112 of structure 110 may be placed about 18 feet apart on center, though other distances are contemplated, such as about 11.5 feet. Additionally, a distance between each mounting member 118, or between mounting member sets, may be as large as about 3 feet. Structural columns 112, fasteners 120, and mounting members 118 are expected to hold a permanent load of approximately 2 pounds-per-square-foot, including at least insulation 122, fasteners 134, 138, sound mitigation segments 130, sound mitigation layers 132, and acoustic blankets 136. In addition, structural columns 112, fasteners 120, and mounting members 118 may support at least 15 pounds per lineal foot and a temporary lateral load of at least about 5 pounds-per-square-foot in cases of wind pressure differential.

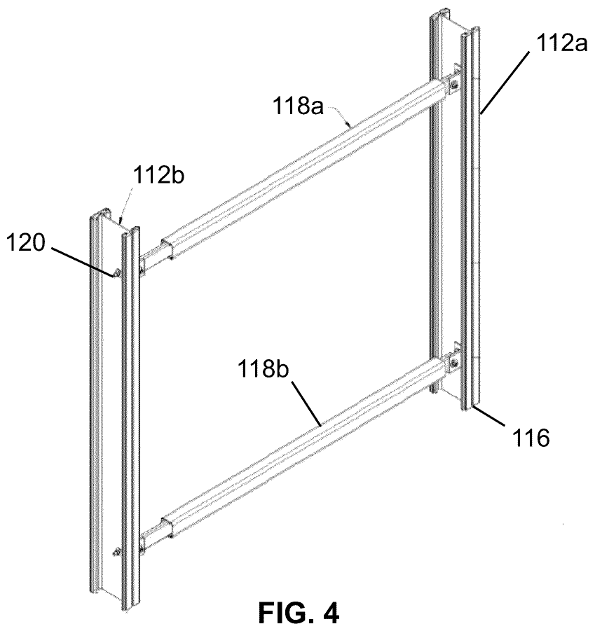

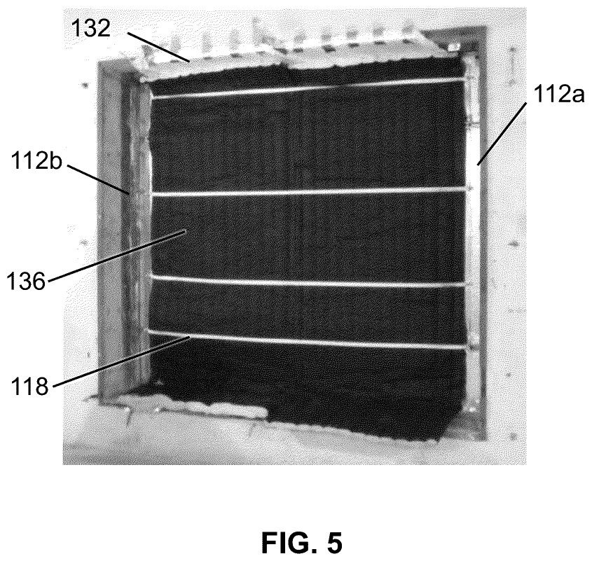

In FIG. 4, an isometric view of structural columns 112, mounting members 118, and fasteners 120 is shown for clarity purposes. As shown, a first structural column 112a may be spaced from a second structural column 112b by a number of feet. For example, first and second structural columns may be spaced apart by 11 to 18.5 feet. A first mounting member 118a and a second mounting member 118b may span between first structural column 112a and second structural column 112b. Fasteners 120 may be used to connect first and second mounting members 118a, 118b to first and second structural columns 112a, 112b. FIG. 5 shows the structure of FIG. 4 with the sound mitigation layer 132 and acoustic blanket 136 attached, and demonstrates that system 100 may be incorporated into a number of existing structures, such as windows. As shown, multiple mounting members 118 may be disposed between first and second structural columns 112a, 112b. Sound mitigation layer 132 may be connected to mounting members 118 and to any surrounding area. For example, as shown, sound mitigation layer 132 may be adhered to a wall. Acoustic blanket 136 may be connected to mounting members 118 and sound mitigation layer 132. In aspects, mounting members 118 may be flat bars of material, such as aluminum tubing or the like. System 100 may also include support bars of material, such as aluminum tubing, in addition to mounting members 118. For example, support bars may be disposed on an opposite side of acoustic blankets 136 or sound mitigation layers 132 than are mounting members 118.

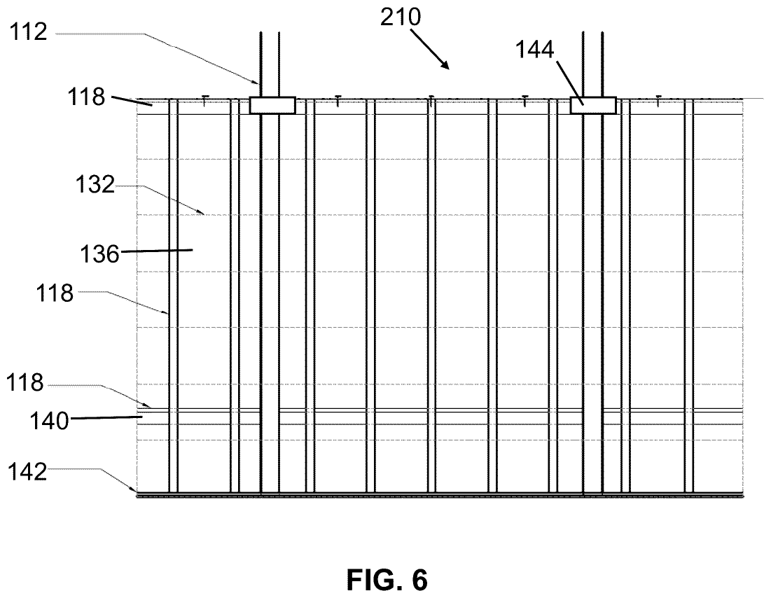

FIG. 6 shows an alternate structure 210 of system 100, with mounting members 118 mounted vertically and fabricated from a wood, such as a fire-retardant treated wood (FRT). In structure 210, structural columns 112 may still be fabricated from a metal, such as a steel or an aluminum. Structure 210 includes one or more horizontal spreaders 140, which may be manufactured from a metal or an FRT, and which may connect to structural columns 112 using one or more fasteners. One or more mounting members 118 may be horizontally mounted to the spreaders 140, and may also be attached using one or more fasteners. The fasteners used to connect spreaders 140 to structural columns 112 and/or mounting members 118 to spreaders 140 may be sheet metal screws, bolts, or the like. The horizontal mounting members 118 and the vertical mounting members 118 may have the same thickness, for example, about 2 inches. The horizontal mounting members 118 may be of an increased width in comparison to the vertical mounting members 118. For example, the horizontal mounting members may be about 6 inches wide, while the vertical mounting members may be about 4 inches wide. The mounting members 118 which are installed vertically may be evenly spaced at about two feet on center. Structural columns 112 and vertical mounting members 118 may be attached to a bottom plate 142, which may be made from pressure treated wood. In aspects, bottom plate 142 may be a pressure treated 2×4.

When using structure 210, sound mitigation layers 132 and acoustic blankets 136 may be horizontally run, as indicated by the dashed line, and secured to vertical mounting members 118 using fasteners 134, 138. To apply sound mitigation layers 132 both horizontally and vertically, sound mitigation layers 132 may be stored in spools, which may be unwound and secured to mounting members 118. Sound mitigation layers 132 and acoustic blankets 136 may be horizontally run up to 14 feet high on structure 210, at which point structure 210 may curve inwards. At about 14 feet, a horizontal mounting member 118 may be disposed, and may be connected to structural column 112 by a plate 144. Plate 144 may be formed from a metal, such as aluminum, and may be connected to structural column by fastener 120. Another fastener type may connect plate 144 to mounting member 118. At a point at which structure 120 curves inwards, a wedge (not shown) may be connected to structural column 112 to facilitate attachment of tubing, mounting members 118, or the like. The wedge may be made from a plastic such as PVC, a wood, or any other suitable material.

Fasteners 120 may be or include self-tapping metal screws, wood screws, insulation board washers, nuts, and T-bolts. To aid in accomplishing repetitive processes, collated screws may be used, for example, as fasteners 134, 138, to attach sound mitigation layers 132 and/or acoustic blankets 136 to mounting members 118, respectively. To attach sound mitigation layers 132 to mounting members 118, nails such as cap nails, as opposed to screws and washers, may be used. When mounting members 118 are fabricated from FRT, all fasteners 120, 134, 138 must be galvanized, must include a coating suitable for chemically treated wood, or the like. All fasteners 120, 134, 138 may additionally include improved gripping characteristics, such as a ring-shank.

System 100, whether using structure 110 or structure 210, provides consistent sound attenuation benefits. Sound attenuation mechanisms include absorption, reflection, diffusion, and transmission loss. Sound energy may be absorbed by soft, porous materials and converted into heat, thus reducing noise levels. Reflection occurs when sound waves bounce off of a hard surface, therefore directing sound away from the source. When sound waves are diffused, they are scattered in varying directions, reducing the intensity of the sound waves by spreading them over a large area. Finally, sound undergoes transmission loss when sound energy passes through a dense barrier, such as mass-loaded vinyl. To determine sound attenuation, ratings such as Sound Transmission Class (STC), Noise Criterion (NC), and Noise Reduction Coefficient (NRC) are used.

STC describes how well components of a structure reduce sound transmission, for example, how effectively the walls, floors, ceilings, and so on block airborne sound. Higher STC values indicate better soundproofing performance. At values between 40 and 50 STC, loud speech is barely audible through a partition. For system 100, the partition formed by structural columns 112, mounting members 118, insulation 122, sound mitigation layers 132, and acoustic blankets 136 is 48 STC or higher, and may be increased by increasing a thickness, or a number, of any of the aforementioned materials.

NC is a rating system used to measure and specify acceptable indoor background noise levels, therefore ensuring a comfortable acoustic environment. Higher NC values indicate higher acceptable noise levels. For example, for auditoriums and theaters, an NC value of 20 or lower is ideal to optimize acoustics and prevent interference or distraction with performances. System 100 ensures NC of 15 or less.

NRC is a numerical rating which indicates the sound-absorbing effectiveness of a material. NRC measures how much sound a particular material can absorb as opposed to reflecting the sound back into the room. NRC is measured between 0 and 1, with an NRC of 0 indicating that the material reflects all sound and absorbs none, and an NRC of 1 indicating that the material absorbs all sound. System 100 has an NRC of 0.9, demonstrating that system 100 is configured to absorb nearly all sound.

Certain aspects of this disclosure may include some, all, or none of the above advantages and/or one or more other advantages readily apparent to those skilled in the art from the drawings, descriptions, and claims included herein. Moreover, while specific advantages have been enumerated above, the various aspects of this disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein.

Specific structural and functional details disclosed herein are not to be interpreted as limiting, but as a basis for the claims and as a representative basis for teaching one skilled in the art to variously employ this disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in this disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of this disclosure. Various alternatives and modifications can be devised by those skilled in the art without departing from the disclosure. Accordingly, this disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for sound attenuation and sound abatement, comprising:
a structural column including a first flange, a second flange, and a connecting portion;
a mounting member attached to a front side of the second flange of the structural column;
insulation disposed between the first flange and the second flange of the structural column, wherein the insulation is configured to dampen sound;
an architectural membrane disposed in part behind the first flange of the structural column and configured to partially cover the insulation;
a vapor barrier disposed in part behind the second flange of the structural column and configured to partially cover the insulation;
a first sound mitigation layer at least partially covering the mounting member; and
an acoustic blanket at least partially covering the sound mitigation layer.

2. The system of claim 1, further including a second sound mitigation layer disposed between a front side of the second flange of the structural column and the mounting member.

3. The system of claim 1, wherein the mounting member is fabricated from at least one of aluminum or fire-retardant treated wood.

4. The system of claim 1, wherein the structural column further defines a slot on at least one of the first flange or the second flange, wherein the slot is configured to accommodate a fastener.

5. The system of claim 4, wherein a fastener at least partially disposed within the slot attaches the mounting member to the structural column.

6. The system of claim 1, wherein the insulation includes a first insulation layer and a second insulation layer.

7. The system of claim 1, further including an insulation blanket flap, wherein the insulation blanket flap is at least partially adhered to the connecting portion of the structural column.

8. The system of claim 1, wherein the vapor barrier is integrated with the insulation.

9. The system of claim 1, wherein the insulation has a thickness of at least 14 inches.

10. The system of claim 1, wherein the sound mitigation layer is mass-loaded vinyl.

11. The system of claim 1, wherein the system meets a sound transmission class (STC) rating of at least 48.

12. The system of claim 1, wherein the system meets a noise criterion (NC) rating of 15 or less.

13. The system of claim 1, wherein the system has a noise reduction coefficient (NRC) of at least 0.9.

14. A system for sound attenuation and sound abatement, comprising:
insulation configured to dampen sound and configured to be disposed between a first flange and a second flange of a structural column;
a vapor barrier configured to at least partially cover the insulation;
a first sound mitigation layer configured to at least partially cover a mounting member, wherein the mounting member is attached to the structural column; and
an acoustic blanket configured to at least partially cover the sound mitigation layer.

15. The system of claim 14, further including a second sound mitigation layer configured to be disposed between a front side of the second flange of the structural column and the mounting member.

16. The system of claim 14, wherein the insulation has a thickness of at least 14 inches.

17. The system of claim 14, wherein the system meets a sound transmission class (STC) rating of at least 48.

18. The system of claim 14, wherein the system meets a noise criterion (NC) rating of 15 or less.

19. The system of claim 14, wherein the system has a noise reduction coefficient (NRC) of at least 0.9.

20. A method of sound attenuation and sound abatement, comprising:
inserting insulation between a first flange and a second flange of a structural column, wherein the insulation spans an area across which sound dampening is desired;
adhering a first sound mitigation layer to a front side of the second flange of the structural column;
attaching a mounting member to the structural column, wherein the first sound mitigation layer is disposed at least partially between the mounting member and the structural column;
at least partially covering the mounting member with a second sound mitigation layer, wherein the second sound mitigation layer spans at least the area across which sound dampening is desired; and
at least partially covering the mounting member with an acoustic blanket, wherein the acoustic blanket spans at least the area across which sound dampening is desired.
